(19) United States
(12) Patent Application Publication
(10) Pub. No.: US 2016/0334912 A1
(43) Pub. Date: Nov. 17, 2016

(54) Force Curves and Inadvertent Input Control

(71) Applicant: Microsoft Technology Licensing, LLC, Redmond, WA (US)

(72) Inventor: Flavio Protasio Ribeiro, Bellevue, WA (US)

(21) Appl. No.: 14/713,723

(22) Filed: May 15, 2015

(51) Int. Cl. G06F 3/041; G06F 3/044

(52) U.S. Cl. CPC G06F 3/0414; G06F 3/044

(57) ABSTRACT

Inadvertent input control techniques are described. In one or more implementations, techniques are described that leverage force to determine a likelihood that a user intended to provide an input, e.g., a selection input (e.g., a “click”), gesture, lift off, and so forth. This is usable to identify taps, hovers, continuation of movement of a drag operation, and so on Implementations are also discussed that leverage an n-manifold in the product space of contact size and signal strength that is usable to define a likelihood of whether a contact includes an application of force. A variety of other examples are also described, including cursor stability techniques that leverage force in order to control movement of a cursor.

### BACKGROUND

Detection of touch inputs may be utilized to support a variety of functionality. For example, trackpads may be found on a variety of different devices to support cursor control and gestures, such as on a laptop, removable keyboard cover for a tablet, and so on. In some instances, the trackpads also include functionality usable to initiate a selection (e.g., a “click”) and thus movement of a cursor and selections may be made by a user without requiring a user to remove a finger from the trackpad to press a separate button. Touch functionality may also be included in a variety of other devices, such as part of a touchscreen of a mobile phone or tablet, keyboard sensor array, and so on.

In some instances, however, a user may inadvertently provide a touch input, which could interfere with the user's experience. For example, a user may type on a keyboard and “hover” a finger over the trackpad, which may then result in an inadvertent tap due to fatigue, being jostled, and so forth. In the case of composing a document, this may cause a cursor to be moved elsewhere in the document. If the user does not notice this movement, the typing may continue at that point, which may be frustrating. These frustrations may also be encountered in other situations, such as when browsing the Internet, composing a drawing, and so forth.

### SUMMARY

Inadvertent input control techniques are described. In one or more implementations, techniques are described that leverage detection of applied force to determine a likelihood that a user intended to provide an input, e.g., a selection input (e.g., a “click”), gesture, lift off, and so forth. This is usable to identify taps, hovers (e.g., noncontacts or contacts that are viewed at a level below a threshold), continuation of movement of a drag operation, and so on. Implementations are also discussed that leverage a curve, surface or n-manifold in a product space of contact size and signal strength that is usable to define a likelihood of whether a contact includes an application of force. A variety of other examples are also described, including cursor stability techniques that leverage force in order to control movement of a cursor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the inadvertent input control techniques described herein.

FIG. 2 depicts an example of a force sensor that includes a haptic feedback mechanism employing piezos to detect force and provide haptic feedback and a position sensor usable to detect a relative location of an object.

FIG. 3 depicts a system in an example implementation showing inadvertent input control for selection inputs by a force control module.

FIG. 4 depicts an implementation showing first, second, and third examples of force signatures expressed as waveforms.

FIG. 5 depicts an example implementation of control of an inadvertent input involving a hover.

FIG. 6 depicts an example implementation of control of an inadvertent input involving a long-duration hover.

FIG. 7 depicts an example implementation of control of an inadvertent input involving a selection input and movement.

FIG. 8 depicts an example implementation of control of an inadvertent input involving release of a selection input and movement.

FIG. 9 depicts a system in an example implementation showing techniques usable to control a cursor during press down using force by a force control module.

FIG. 10 depicts a system in an example implementation showing techniques usable to control a cursor during lift off using force measurements by a force control module.

FIG. 11 depicts a system in an example implementation showing techniques usable to control a cursor using measured forces by a force control module to control a gain factor that maps the velocity of an object to the velocity of an on-screen cursor.

FIG. 12 depicts a system in an example implementation usable to employ techniques regarding force curves and inadvertent input control.

FIG. 13 depicts an example implementation for a real measured operating characteristic, obtained on a manually operated mechanism over a single touch location.

FIG. 14 is a flow diagram depicting a procedure in an example implementation in which curves are used to classify whether or not reports are likely indicative of advertent or inadvertent inputs.

FIG. 15 illustrates an example system including various components of an example device that can be implemented as any type of computing device as described with reference to FIGS. 1-14 to implement embodiments of the techniques described herein.

### DETAILED DESCRIPTION

Overview

Inadvertent inputs captured by touch-enabled devices may interfere with a user's experience when interacting with the devices. This may cause inadvertent selections, unintended movement of a cursor, erroneous gestures, and so forth which may be frustrating to the user.

Inadvertent input control techniques are described. In one or more implementations, force is utilized at least in part to determine a likelihood that a user intended to provide an input. In a first example, a force waveform is used to determine whether a tap is intended by a user. In a second example, a force waveform is used to determine a likelihood of whether an input detected by position sensors (e.g., by capacitive sensors) is intended by a user through verifying whether force is detected by force sensors. In a third example, contacts are ignored that occur after long-duration hovers as the likelihood is greater that a user intended to hover a finger over a trackpad than wanting to initiate the input.

Cursor stability techniques are also described. In one or more examples, force is used to cause a cursor to remain stable, such as for a press-down or lift-off of an object from a trackpad. This may be performed through detection of an amount of force, used to reduce cursor velocity gain, and so on. In this way, the effect of movements of centroids of a contact region caused by a press or release may be minimized.

Techniques are also described in which an amount of force is inferred from a position sensor without use of a dedicated force sensor. Values of a contact size (e.g., area) and signal strength (e.g., amplitude) from position sensors (e.g., capacitive sensors, sensor-in-a-pixel configurations, and so on) are compared to a curve, surface or (in general) n-manifold defined in a product space of contact size and signal strength that is usable to detect a prescribed amount of force applied to the outer surface of the position sensors. A product space is a Cartesian product of a family of topological spaces equipped with a natural topology called a product topology. For example, points above the n-manifold are considered indicative of force and points below the n-manifold are not, resulting in a zero force n-manifold. Thus, the n-manifold is also usable to determine a likelihood that a user intended to initiate an input, maintain an input (e.g., as part of a select-and-drag operation), and so forth. Further discussion of these and other examples is included in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures as further described below.

Example Environment

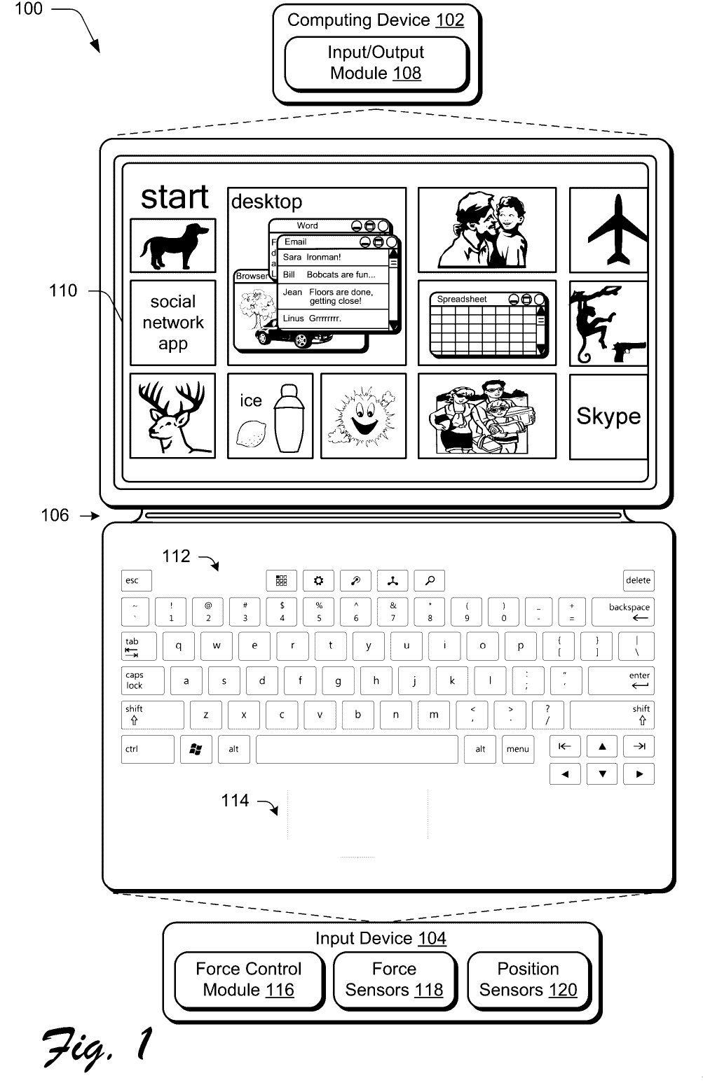

FIG. 1 is an illustration of an environment 100 in an example implementation that is operable to employ the inadvertent input control techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on. Thus, the computing device 102 may range from full resource devices with substantial memory and processor resources to a low-resource device with limited memory and/or processing resources. The computing device 102 may include software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110. Thus, the input/output module 108 may support a variety of different input techniques by recognizing and leveraging a division between types of inputs including key presses, gestures, and so on.

In the illustrated example, the input device 104 is configured as having an input portion that includes a keyboard 112 having a QWERTY arrangement of keys and a track pad 114, although other arrangements of keys are also contemplated. Further, other non-conventional configurations are also contemplated, such as a game controller, a configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin (although that embodiment is also contemplated). Further, this flexible rotation may be configured to support movement in one or more directions (e.g., vertically in the figure) yet restrict movement in other directions, such as lateral movement of the input device 104 in relation to the computing device 102. The flexible hinge 106 may be used to support consistent alignment of the input device 104 in relation to the computing device 102, such as to align sensors used to change power states, application states, and so on.

The flexible hinge 106 may be formed using one or more layers of fabric and include conductors formed as flexible traces to communicatively couple the input device 104 to the computing device 102 and vice versa. This communication may be used to communicate a result of a key press to the computing device 102, receive power from the computing device, perform authentication, provide supplemental power to the computing device 102, and so on.

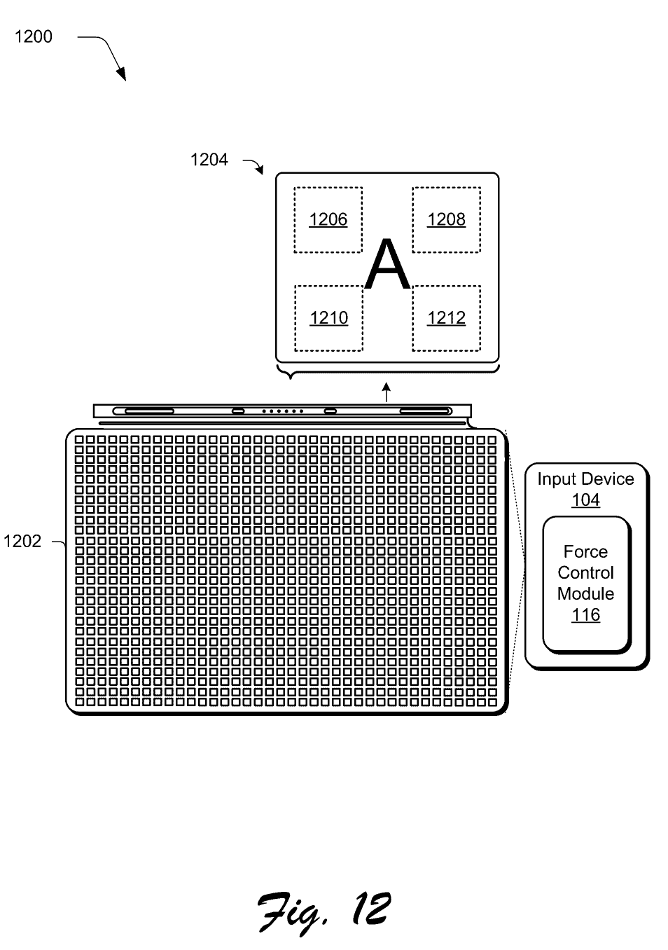

The input device is also illustrated as including a force control module 116 that is representative of using force control techniques to manage inadvertent and advertent inputs. The input device 104, for instance, may include force sensors 118 and position sensors 120. Force sensors 118 are configurable in a variety of ways, such as through use of piezos, force sensitive resistors, strain gauges, and so forth. Force sensors are usable to provide a single indication of force summing of all contact forces or provide a technique to calculate an amount of force on a per sensor force reading. Position sensors 120 are configured to detect a relative location of an object, such as a finger of a user's hand, to control movement of a cursor, input gestures, and so forth. The force sensors 118 and position sensors 120 may be configured in a variety of ways for inclusion in a variety of devices, such as part of the trackpad 114, keys of a keyboard arranged in a sensor array as shown in FIG. 12, as part of touchscreen functionality of the display device 110, and so forth. Accordingly, although trackpad implementations are described in the following discussion, these implementations are equally applicable to other device and usage scenarios.

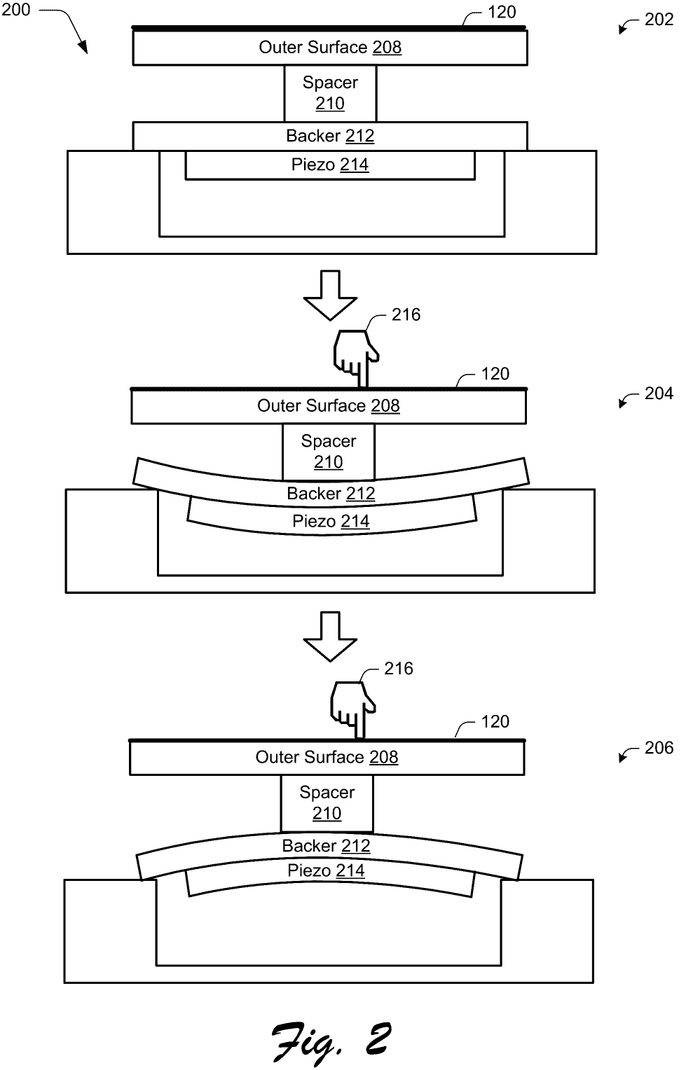

FIG. 2 depicts an example 200 of a force sensor 118 employing piezos to detect force and provide haptic feedback and a position sensor 120 usable to detect a relative location of an object. This example is illustrated using a first stage 202, a second stage 204, and a third stage 206. The mechanism includes an outer surface 208, such as the surface of a trackpad or the key of a keyboard. The outer surface 208 may be formed from a variety of different materials and combinations thereof, such as glass, plastic, a laminate structure, and a fabric outer layer.

The outer surface 208 includes the position sensors 120 of FIG. 1 that are configured to detect a relative location of an object in relation to the outer surface 208. The position sensors 120 may be formed from a variety of different sensor types, such as capacitive sensors (e.g., a capacitive array), sensor-in-a-pixel, optical sensors, resistive sensors, and acoustic sensors.

The outer surface 208 is coupled mechanically to a spacer 210 that is coupled mechanically to a backer 212. The spacer 210 is configured to channel force applied to the outer surface 210 to a central region of the backer 212 and thus to a piezo 214 connected thereto. In this way, an amount of deflection of the backer 212 and the corresponding piezo 214 is increased in response to the force, even on “off center” presses, thereby supporting a greater sensitivity to detection of an amount of force and haptic response.

The backer 212 is formed from a rigid material (e.g., steel, plastic, and the like) and is physically coupled to the piezo 214. Accordingly, as illustrated in the first stage 202, when a force is not applied to the outer surface 208 (and thus no force is applied to the backer 212), the piezo 214 is not strained and as such does not output a voltage.

At the second stage 204, an object 216 such as a finger of a user's hand (not shown in scale) applies a force as part of pressing down on the outer surface 216) that causes deflection of the backer 212 and thus strain on the piezo 214, resulting in an output voltage that is detectable by the force sensing and haptic feedback module 116. As the voltage output by the piezo 214 changes with an amount of force applied, the piezo 214 is configured to detect not just the presence or absence of force, but also an amount of force, e.g., a respective one of a plurality of levels of force. The piezo 214 is configurable in a variety of ways, such as being formed at least in part from a piezo ceramic material, PZT, an electroactive polymer, or an electromechanical polymer.

The piezo 214 is also usable to provide a haptic feedback, as shown at the third stage 206. Continuing with the previous example in the second stage 204, the piezo 214 detects an amount of force applied to the outer surface 208 by the finger of the user's hand. If the detected force is over a threshold, the force control module 116 energizes the piezo 214. This causes the piezo 214 to pull against the backer 212 and thus deflect outward back toward the object 216 applying the force, thereby providing a haptic response.

In this way, the piezo 214 is leveraged to provide both force sensing and haptic feedback. Other examples are also contemplated. For instance, force may be sensed by a force sensor that is not the piezo and then the piezo may be used to provide haptic feedback. In another instance, a first piezo may be used to detect force and a second piezo may be used to provide haptic feedback. As described above, force sensors 118 are also configurable without piezos while not departing from the spirit and scope of the techniques described herein.

Force Sensing and Inadvertent Input Control

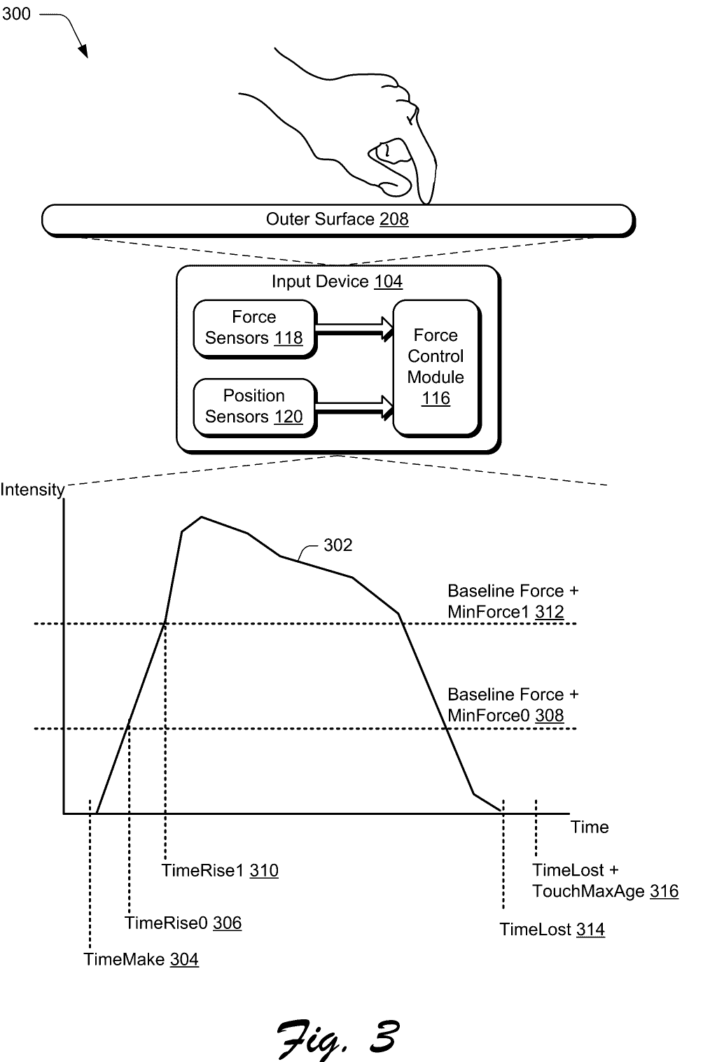

FIG. 3 depicts a system 300 in an example implementation showing inadvertent input control for selection inputs by a force control module 116. A selection input may be thought of as a brief light tap on the outer surface 208 of an input device (e.g., trackpad), which in some instances is not strong enough to trigger a haptic response as described in relation to FIG. 2. Other examples of a selection input are also contemplated in which a “press” is controlled, such as a selection input that has sufficient strength to initiate a click and haptic response, e.g., as a button press of a mouse.

In this example, the force control module 116 is configured to control results of inadvertent inputs through use of a force signature 302 that is expressed as a waveform formed by reports obtained by the force control module 116 from the force sensors 118. The force control module 116 is configured to block further communication of reports from the force sensors 118 and the position sensors 120 that do not meet criteria for an input, e.g., repressing the associated contact such that a touch detection is not reported to the computing device 102, marking the contact as invalid (e.g., by clearing a confidence bit), and so on.

The force control module 116 obtains reports from the force sensors 118 that sample force readings continuously at a sampling rate. In one or more implementations, the reports (e.g., readings) are spaced-out by no more than one or two milliseconds. An exception may be made for simpler parameter extraction, such as to judge simple presence to distinguish from hovering. In those cases it may be permissible to sample at an even slower rate. The reports may be maintained by the force control module 116 in a buffer, such as a circular buffer, to hold approximately fifty milliseconds worth of samples.

A check is first made by the force control module 116 for proper operating conditions, such as to start with zero contacts on the trackpad for cases involving single taps. The force control module 116 waits for an indication of detection of a contact (e.g., a finger of the user's hand in the illustrated example) to arrive. There may be a delay between contact (e.g., a finger touching down) and a controller of the position sensors 120 reporting the contact. The delay may be caused by a limited frame rate of the position sensors 120 (e.g. 8 ms), noise filtering performed by the controller, and so on.

Accordingly, a leading edge of the waveform of the force signature 302 associated with a new contact by the force sensors 118 generally precedes the report from the position sensors 120. This delay is generally variable, typically varying from between five and fifteen milliseconds. When a report arrives from the position sensors 120, force reports are fetched backwards in time (e.g., up to about 15 ms) from the cache by the force control module 116 to ensure that the leading edge of the waveform of the force signature 302 is captured.

Once the force signature 302 is captured, the force control module 116 first locates a leading edge in the waveform. As discussed above, there may be some uncertainty about where this leading edge is found. Parameters from the waveform are then extracted as described below, such as a slope of leading edge and a magnitude (e.g., maximum height).

If the force signature 302 appears to satisfy an intentional selection input (e.g., a “tap”), the force control module 116 is configured to register and permit communication of this information to the input/output module 108 of the computing device 102. Thus, the computing device 102 may also make conclusions about whether the reports reflect an intentional input.

If the force signature 302 does not have a likelihood of being intentional, a variety of different actions may be performed. The force control module 116, for instance, may indicate this lack of confidence to the computing device 102. The input/output module 108 of the computing device 102 is then free to make determinations, e.g., the force signature 302 may still be treated as an intentional selection input. Other examples are also contemplated, such as to block further communication of the reports by the force control module 116 and/or input/output module 108 from proceeding onward, e.g., to the operating system or applications as inputs.

In one or more implementations, the force control module 116 is configured to monitor the contact to decide whether the contact would be interpreted by the computing device 102 as a selection input, e.g., as a tap. For example, if the contact is lifted at no more than 300 milliseconds later, then the force control module 116 is aware that the reports will be interpreted as a tap by the computing device 102. Accordingly, when the object is lifted from the outer surface 208, the confidence bit that asks the computing device 102 to repress the tap is cleared by the force control module 116.

The force control module 116 calculates a force baseline by averaging an initial plurality of the reports of the force signature 302. A rise in force is located in the force signature 302 over the baseline that meets a defined minimum value. As shown in FIG. 3, for instance, TimeMake 304 marks the beginning of the force signature 302.

The force control module 116 then locates and records a first time (e.g., TimeRise0 306) at which the amount of force in the force signature 302 reaches a first threshold value, e.g., BaselineForce plus MinForce0 308. The force control module 116 also locates and records a second time (e.g., TimeRise1 310) at which the amount of force in the force signature 302 reaches a second threshold value, e.g., BaselineForce plus MinForce1 312, which is greater than the first threshold value. A rise time is then calculated based on the recorded first and second times, e.g., TimeRise0 306 and TimeRise1 310, and thus a slope of the leading edge of the force signature 302 is known.

The force control module 116 then reviews the recorded first time to ensure that the value does not exceed a defined maximum value. The force control module 116 also reviews the slope of the attack of the leading edge of the waveform of the force signature 302 to ensure the slope meets a defined minimum threshold. If so, the force control module 116 determines that it is likely that the force signature 302 represents a valid selection input, e.g., a tap, click, and so forth. Likewise, if the slope does not meet the defined minimum threshold, the force control module 116 may determine that it is likely that the force signature 302 does not represent a valid selection input.

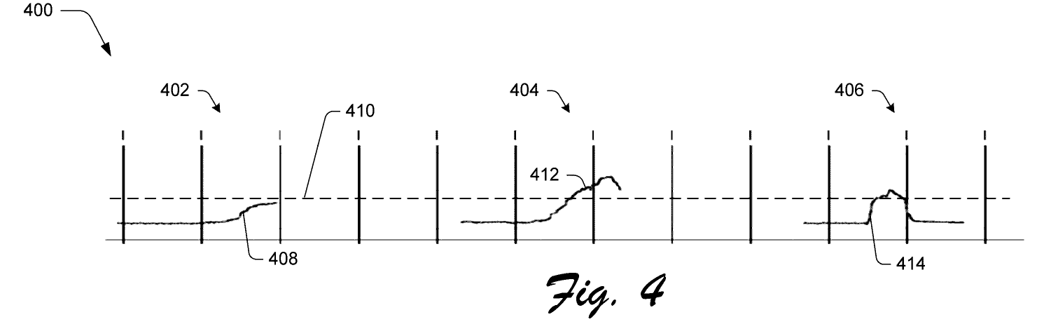

FIG. 4 depicts an implementation 400 showing multiple examples of force signatures expressed as waveforms. In the first example 402, the slope 408 is greater than the defined minimum threshold but the magnitude 410 has not reached the first threshold level, and therefore the force control module 116 determines that the detected object is not likely intended as a selection input. In the second example 404, the magnitude 410 has reached the first threshold level but the slope 412 is not greater than the defined minimum threshold, and therefore the force control module 116 determines that the detected object is not likely intended as a selection input. In the third example 406, the slope 414 is greater than the defined minimum threshold and the magnitude 410 has reached the first threshold level so the force control module 116 determines that the detected object likely involves an intended input.

In one or more implementations, the force control module 116 employs different modes to control determination of inadvertent inputs. The modes in the following refer to the system's inference of how a user is interacting with the input device 104 and/or the computing device 102 as a whole and define sets of parameters for the force control module 116 to determine the likelihood of an intentional input, e.g., the time and force parameters noted above. These parameters may be dynamic, providing greater or lesser defenses against taps, to provide the greatest defenses without imposing undo reductions in tap responsiveness.

In one example, the force control module 116 reverts to a “hard mode” when key presses are not detected or when the force control module 116 detects a prolonged period of input device disuse. In this way, difficulty in registering selection inputs is increased for situations in which it is suspected that the user is not using the trackpad. In the hard mode, the slope and force requirements are more stringent and thereby involve more clearly deliberate taps than when in an “easy mode.” Following this example, the force control module 116 may switch to the easy mode when a hard tap occurs in the hard mode, when the user moves a cursor a minimum distance, and so on. When the cursor is moved, for instance, the force control module 116 may be fairly certain that the user intends to interact with the trackpad and thus the defenses against inadvertent inputs (e.g., slope and magnitude) are lowered in the easy mode.

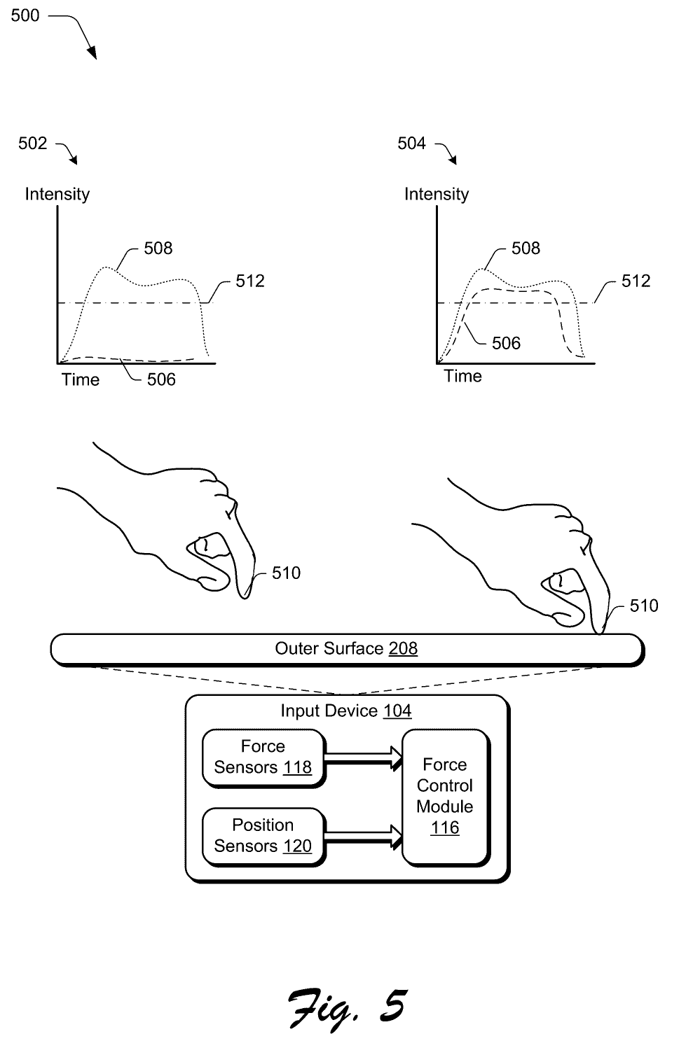

FIG. 5 depicts an example implementation 500 of control of an inadvertent input involving a hover. A hover inadvertent input typically occurs when a nearby object, such as a finger, thumb, or palm, is interpreted as intentional interaction by the input device 104. Accordingly, following the example above, the force control module 116 is configured to ignore contacts having force signatures 302 (e.g., waveforms) that do not meet prescribed criteria (e.g., force signatures 302 indicating hover inadvertent inputs).

The illustration includes a first example 502 and a second example 504. At the first example 502, reports from force sensors 118 form a waveform 506 and reports from position sensors 120 form a waveform 508. The waveform 508 from the position sensors 120 indicates that proximity of an object (e.g., a finger 510 from a user's hand) is detected. This proximity is detected without involving contact of the object with the outer surface 208, e.g., due to enhanced sensing range of capacitive sensors, infrared sensors, and so on.

However, the waveform 506 from the force sensors 118 indicates that minimal to no force is sensed by the force sensors 118, e.g., the magnitude of the waveform 506 is below a defined minimum force threshold 512. Therefore, in the first example 502 the force control module 116 readily determines that there is little to no likelihood of a user intending to initiate an input and responds accordingly, e.g., blocks communication of the reports from the position sensors 120 to the computing device 102, through use of a confidence bit.

In the second example 504, reports received by the force control module 116 from the position sensors 120 indicate proximity of the object (e.g., the finger 510 of the user's hand) through waveform 508. The waveform 508 formed from the reports received from the force sensors 118 also indicates that a force has been received that is above the minimum force threshold 512, and thus the object has contacted and applied the force to the outer surface 208. In response, the force control module 116 determines that it is likely that an input is intended, and responds accordingly as described above, e.g., communicates the reports to the input/output module 108 of the computing device 102 of FIG. 1. Thus, in this example the force control module 116 leverages force to distinguish between a deliberate contact and a hovering force.

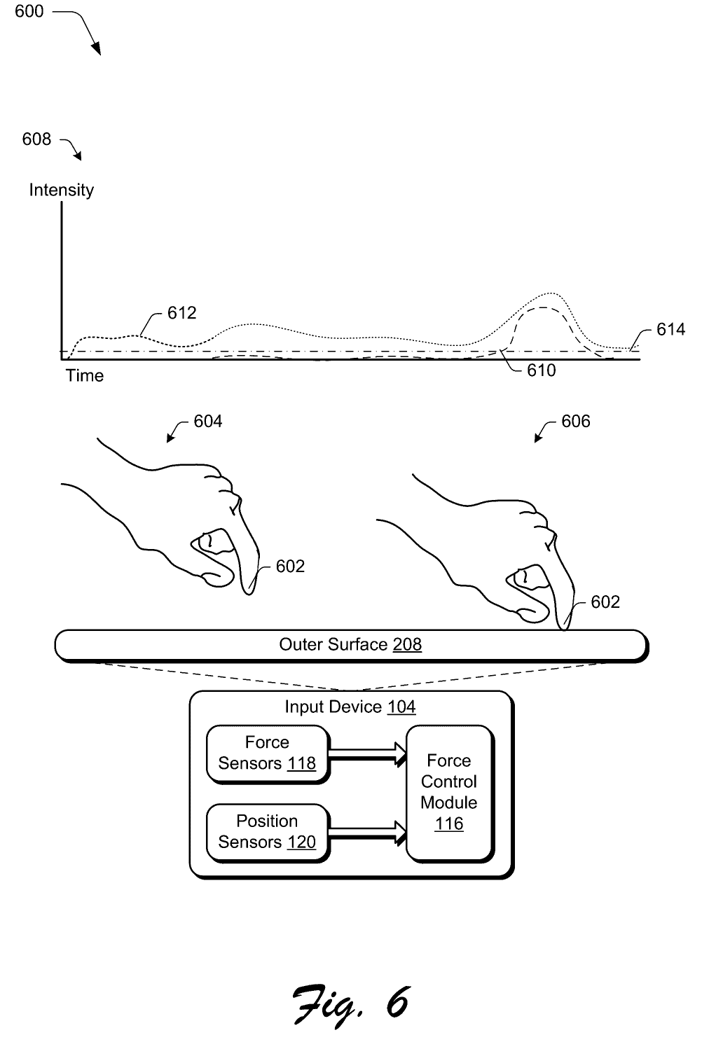

FIG. 6 depicts an example implementation 600 of control of an inadvertent input involving a long-duration hover. One type of inadvertent input involves unwanted contact (e.g., causing a tap, cursor movement, scrolling, zooming) caused by a user's hand 602 that was hovering over a trackpad. The user may have been typing and had a thumb or palm disposed proximal to the position sensors 120 that is consequently detected by the position sensors 120, but is not in contact with the outer surface 208.

In this example, reports of detected amounts of force from the force sensors 118 are used by the force control module 116 to determine that a significant force above a threshold 614 has not been applied (as shown at example 604), and thus contact was not likely made with the outer surface 208. If a contact is subsequently detected (as shown at example 606), the force control module 116 determines the likelihood of intent to initiate an input based on an amount of time the object spent hovering above the outer surface. In this way, the force control module 116 may leverage a realization that deliberate interactions with the trackpad usually do not start out with the user hovering for an extended period of time, but rather a user typically just moves in and interacts with the trackpad, e.g., to perform clicks, drags, gestures, and so on.

This is also illustrated graphically 608 in the figure in which a waveform 610 formed from reports from the force sensors 118 and a waveform 612 formed from reports from the position sensors 120 is shown. As illustrated by the first example 604 of a hover, the waveform 612 from the position sensors 120 does detect proximity but the waveform 610 from the force sensors 118 does not and thus the reports are ignored, e.g., blocked from further processing by the force control module 116.

A period of time progresses in this state, until an application of force to the outer surface 208 is detected by the force sensors 118 (as indicated at example 606) for the waveform 612 and proximity is also detected by the position sensors 120 (as also indicated at example 606) for the waveform 610. If this application of force occurs after a threshold amount of time, the force control module 116 may act to block further processing of the reports and indicate this condition through use of a confidence bit since it is determined that it is not likely that the user intended to initiate an input. Thus, in this example, the position sensors 120 “see” proximity of the object before contact with the outer surface 208 occurs and track this pre-contact proximity. If contact with the outer surface 208 is made after a predefined period of time has passed, the force control module 116 determines that this contact has a low likelihood of being an intentional input.

In one or more implementations, detection of proximity and the amount of force by reports from the force sensors 118 and the position sensors 120 are correlated to distinguish which objects have applied force, an amount of time each object hovers, and so on. For example, the position sensors 120 may sense location as well as a relative strength when sensing the object. If that sensing strength exhibits an increase that coincides with an increase in force, the force control module 116 may assign that detection of force to that object location. Addition or removal of subsequent objects may also be assigned corresponding forces and in this way the force control module 116 may track forces and locations of multiple objects simultaneously to support multiple simultaneous inputs, differentiate amounts of force between objects and corresponding inputs, and so forth.

Additionally, techniques are contemplated in which force is recognized even on a hovering contact, e.g., a level where the force is large enough to be intentional and override and inadvertent lockout. This is performable in a variety of ways, such as through use of a threshold corresponding to a desired amount of force usable to override the lockout.

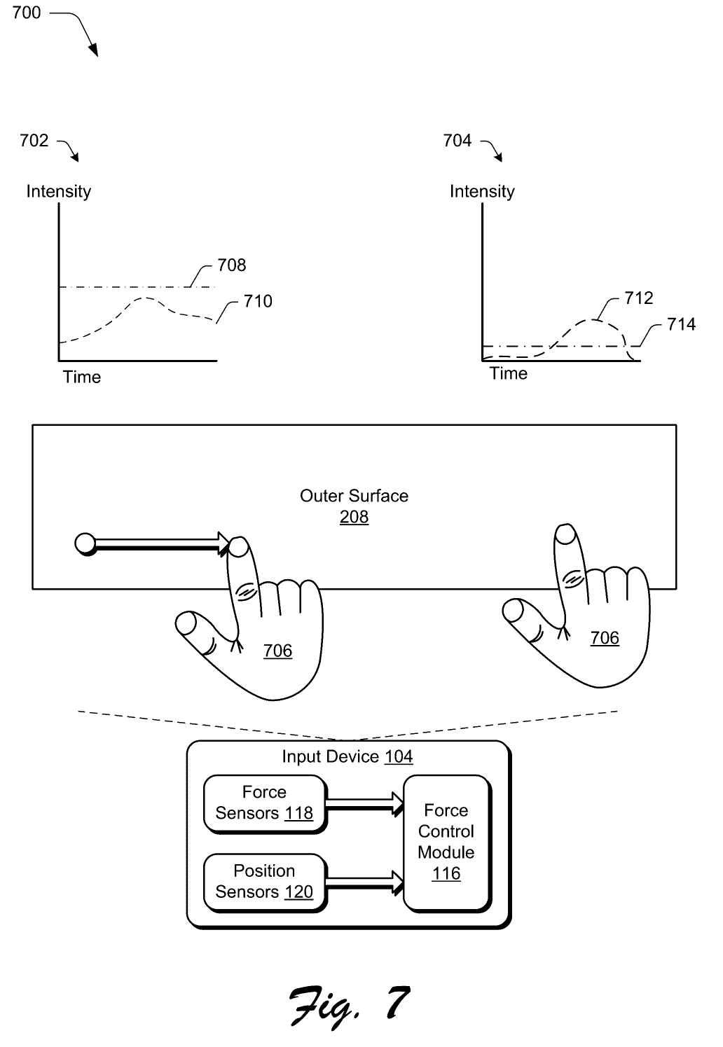

FIG. 7 depicts an example implementation 700 of control of an inadvertent input involving a selection input and subsequent movement as part of a drag operation. This implementation 700 is illustrated using a first example 702 and a second example 704. In conventional mechanical click pads a dome switch is used that mechanically activates whenever an applied force exceeds a fixed threshold. Thus, a moving finger (i.e., a finger performing a drag operation) with sufficient force may still cause an inadvertent button press.

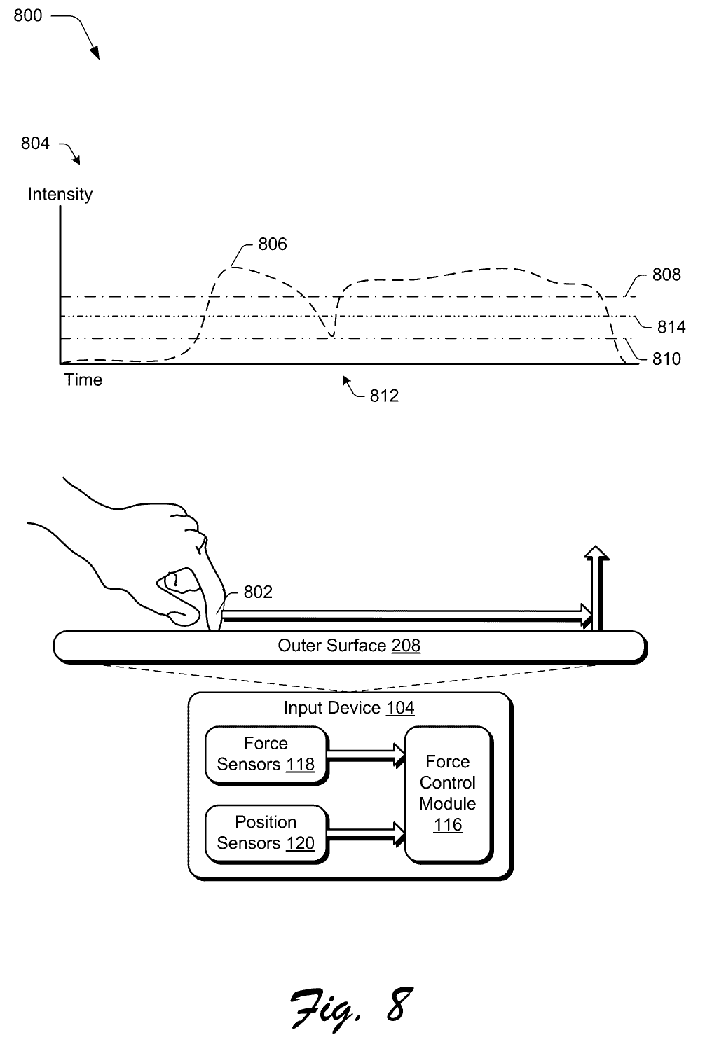

The force control module 116, however, employs force sensing that is usable to control haptic feedback. The force sensing is also usable to determine a likelihood that a user wishes to perform an action, e.g., to initiate a click, to continue or release a drag operation as described in further detail in relation to FIG. 8 below, and so on.

At the first example 702, movement of a finger of a user's hand 706 is illustrated through use of an arrow. The force control module 116 detects movement of the object through the position sensors 120 and utilizes a corresponding threshold 708 to define an amount of force used to initiate the haptic response. Thus, if the force signature 710 remains below this threshold 708 during the movement, the selection input is not initiated, as the force control module 116 has determined that it is unlikely that the user intended to initiate the input.

At the second example 704, however, the force control module 116, through analysis of reports received from the position sensors 120, determines that the object exhibits less than a threshold 708 amount of movement from the first example 702. In response, the force control module 116 uses another threshold 714 to determine likelihood of a user desiring to initiate an input that is lower than the threshold 708 used for movement. Accordingly, if reports of a waveform 712 from a force signature of the force sensors 118 are greater than this threshold 714 (as illustrated), a selection input is initiated, which may include a haptic response (such as a “click” described in relation to FIG. 2). Thus, an inadvertent selection is made less likely yet sensitivity is still preserved through use of an additional threshold 714.

FIG. 8 depicts an example implementation 800 of control of an inadvertent input involving release of a selection input and movement. As described above, in conventional mechanical click pads a dome switch is used that mechanically activates whenever an applied force exceeds a fixed threshold. The conventional click pad is also configured to release whenever an applied force is reduced below a threshold amount, e.g., a return force of the dome switch. Thus, if a user does not maintain enough force during a drag operation of conventional devices, the operation may end before the user intended.

In this example, the force control module 116 is configured to release a haptic response (e.g., a click) for a drag operation if the object applies an amount of force below a threshold 808 and is not moving, i.e., generally stationary. Similarly, the threshold 808 used to define a release may be decreased to threshold 810 during movement in the drag operation to make inadvertent release less likely.

In the illustration of FIG. 8, a finger of a user's hand 802 is illustrated as performing a select and drag operation, movement involved in which is illustrated using arrows along with a graph 804 having a force signature 806 formed as a waveform from reports obtained from the force sensors 118 by the force control module 116. A first threshold 808 is used to determine whether the reports qualify as a selection input as described above, e.g., the “click down.”

A drag operation is then performed which involves movement along the outer surface 208 as illustrated by the arrow. During this movement, a second threshold 810 that is lower than the first threshold 808 is used to determine whether the drag operation is to be released or is considered as continuing on. A third threshold 814 is also used as a release threshold, but is used for zero movement and is thus higher than the second threshold 810. Therefore, even though a point 812 may be encountered in which the amount of force drops below the third threshold 814, as long as the force remains above the second threshold 810 and the movement continues, the drag operation also continues. Once the detected force moves below the second threshold 810, termination of the drag operation is indicated, which may be used by the force control module 116 to provide haptic feedback as described in relation to FIG. 2. In this way, an inadvertent click release is made less likely. A variety of other examples are also contemplated without departing from the spirit and scope of the techniques described herein.

Force Inputs and Cursor Control

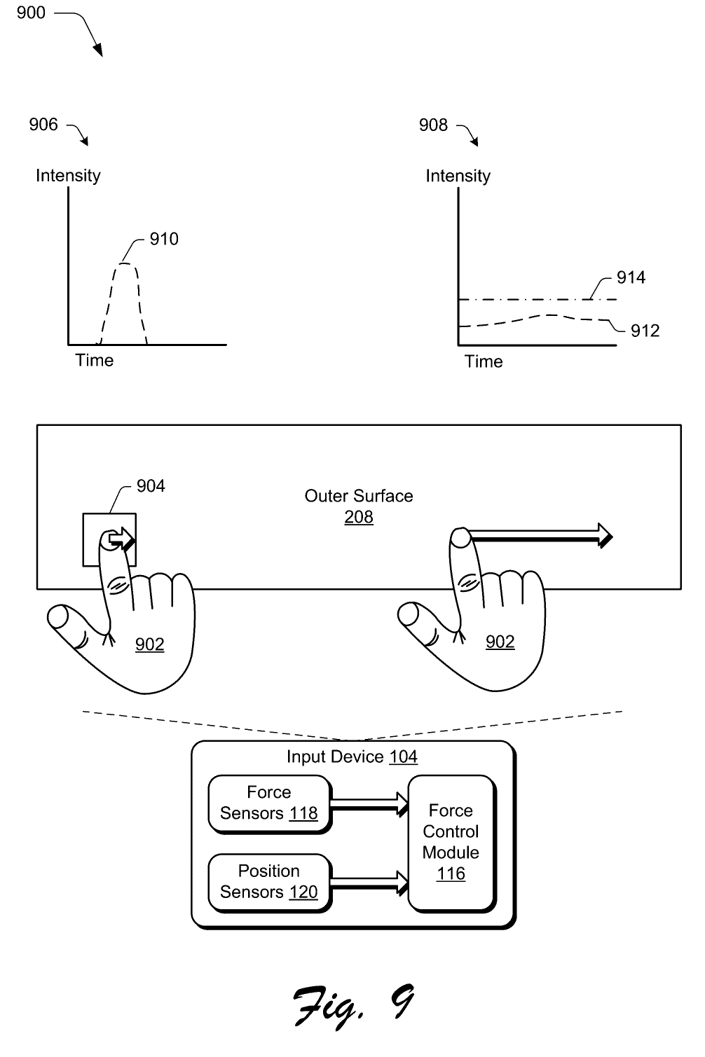

FIG. 9 depicts a system 900 in an example implementation showing techniques usable to control a cursor during push down using force by a force control module 116. When a user pushes down on a trackpad or touchscreen to select an icon, check a box, or so on a cursor may move in conventional scenarios. This effect may be caused by rolling of a fingertip on an outer surface, deformation of the pulp of a fingertip caused by the force (resulting in a shift in a calculated centroid of the contact), and so forth. To address this, techniques may be utilized to hold what is reported as a relative location of an object (e.g., a finger of a user's hand 902) steady when first contacting the outer surface 208 and report movement when a threshold amount of movement is detected, e.g., as defined by a bounding box 904. These techniques may result in decreased responsiveness.

In this implementation, the force control module 116 employs force to control a cursor in place of or in addition to using the bounding box 904 (e.g., to reduce a size of the bounding box 904 and thus decrease the threshold amount of movement detected before movement is reported). The system 900 includes first example 906 and a second example 908.

At the first example 906, a waveform 910 of a force signature is illustrated from reports of the force sensors 118. The waveform 910 in this example includes sufficient slope (as described in relation to FIG. 3) such that the reports are considered indicative of an input, e.g., a selection input as described above. In response to the force illustrated in the waveform 910, the force control module 116 is configured to override small movement reports communicated by the position sensors 120 that may be caused by deformation, rocking, and so on. As such, a cursor remains stationary while an intentional input is detected in the first example 906.

At the second example 908, a finger of a user's hand 902 is moved across the outer surface 208 as illustrated by an arrow. A corresponding waveform 912 formed by reports obtained from the force sensors 118 illustrates an amount of force at various points in time during this movement. A threshold 914 is used in this example such that if the amount of force remains below the threshold 914, movement of the cursor is permitted. Thus, if the force stays light, then a cursor is allowed to move without delay in the second example 908. However, if the force ramps-up rapidly (as illustrated by the slope of the waveform 910 of the first example 906), the force control module 116 determines that the user likely wishes to initiate an input. In this way, the force control module 116 supports increased responsiveness along with protection against inadvertent inputs. Similar techniques are also usable in regard to removal of contact (e.g., lift off), further discussion of which is included in the following and shown in a corresponding figure.

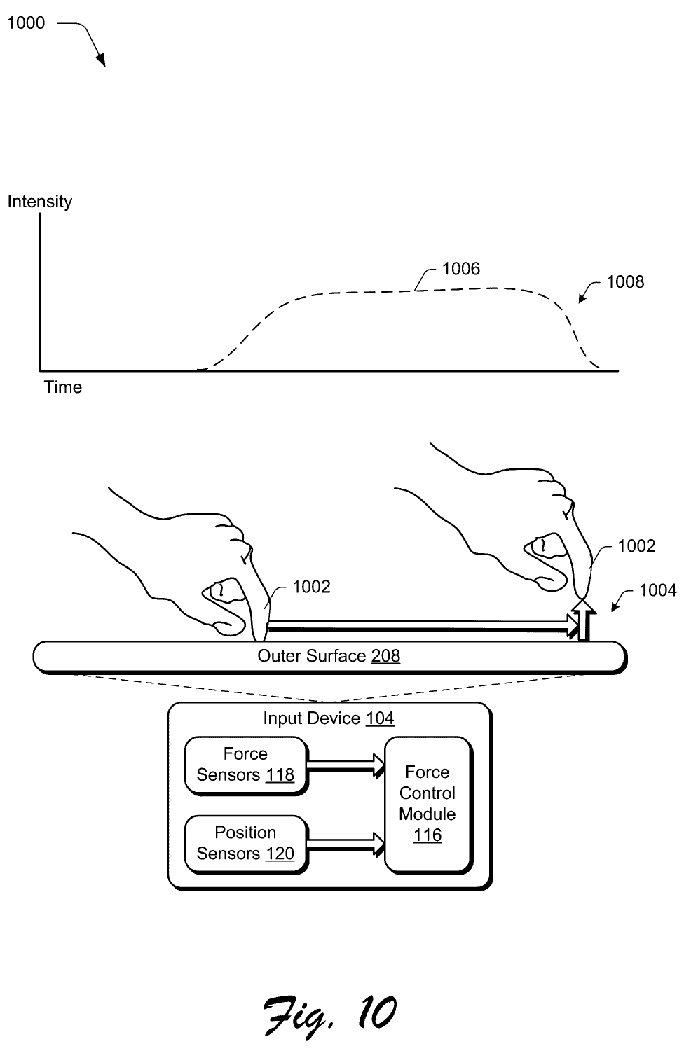

FIG. 10 depicts a system 1000 in an example implementation showing techniques usable to control a cursor during lift off using force measurements by a force control module 116. In the above example of FIG. 9, movement of a cursor that could occur in conventional instances in a press down due to rolling of a fingertip on an outer surface, deformation of pulp of a fingertip caused by the force and thus resulting in a shift in a calculated centroid of the contact, and so forth is described. A similar effect may also be observed on lift off when a finger of a user's hand 1002 is removed from contacting the outer surface 208 and thus in conventional devices could also cause inadvertent movement of a Cursor.

Thus, in this example the force control module 116 is also configured to control cursor movement based on force measurements, but in this instance to use reducing force to halt contact movement on lifts. In the illustrated example, a finger of a user's hand 1002 is illustrated as performing a drag operation, which is then terminated by lifting 1004 the finger of the user's hand 1002 away from the outer surface 208 as illustrated using arrows. A waveform 1006 formed by reports obtained from the force sensors 118 indicating an amount of force over time is shown graphically.

When the finger of the user's hand 1002 is lifted 1004 from the outer surface 208, the force control module 116 detects a rapid decrease 1008 in force in the waveform 1006, e.g., a slope over a defined amount. In response, the force control module 116 determines that a user is likely terminating the drag operation and overrides any movement associated with this rapid decrease 1008 that is detected by the position sensors 120. In this way, the cursor is controlled to be relatively stationary upon lift off by using reducing force identified through slope as described above through time and corresponding intensity thresholds to halt recognized contact movement.

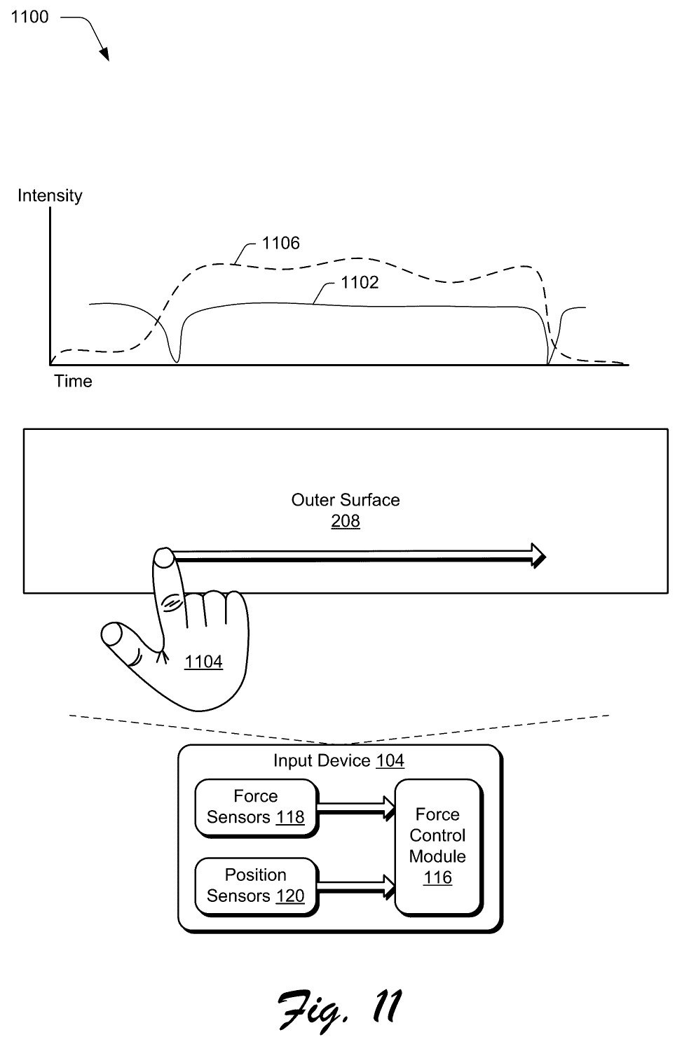

FIG. 11 depicts a system 1100 in an example implementation showing techniques usable to control a cursor using measured forces by a force control module 116 to control a gain factor that maps the velocity of an object to the velocity of an on-screen cursor. Like above, a centroid detected for a location of an object by the position sensors 120 shifts both when a finger is pressed and released. In typical cursor control scenarios, press and release events are performed with a stationary finger of a user's hand.

In this example, a gain factor 1002 maps the physical velocity of movement of an object that is detected by the position sensors 120 to onscreen velocity of a cursor. For example, a finger of the user's hand 1104 may move a half an inch per second and a gain factor 1002 may be used to multiply that movement velocity by a specified amount, which may be dynamically defined, to obtain the onscreen velocity of a cursor.

In the illustrated example, the gain factor 1102 is based at least in part on a rate of variation in an amount of force as detected by the force sensors 118, which is exhibited graphically by a waveform 1106. The gain factor 1102 is attenuated in proportion (e.g., directly, indirectly, dynamically) to an absolute rate of force variation as detected by the force sensors 118. Thus, the gain factor 1102 dips to low values when the waveform 1106 increases or decreases quickly, and remains stable at a nominal level when the waveform 1106 oscillates slowly. The effect is that movement of a cursor is significantly reduced and even eliminated if force applied by an object changes more than a threshold amount. In this way, increased cursor stability is achieved by the force control module 116 while still preserving responsiveness of cursor movement.

Force Curves and Inadvertent Input Control

FIG. 12 depicts a system 1200 in an example implementation usable to employ techniques regarding force curves and inadvertent input control. Conventional multi touch sensors may exhibit a variety of nonlinear behaviors that are compensated for to provide a good user experience. For example, mutual capacitance sensors work because grounded fingers disrupt fringing electrical fields. The intensity of these fields, known as electric flux density, rolls off non-linearly with distance and is dependent on electrode geometry. Additionally, sensors may have edges where uniformity assumptions break down. For example, a finger touching the middle of the touch pad is generally detected by multiple nodes, while a finger located over an edge or corner is often detected by a single node. This again produces errors and introduces biases for all measured quantities.

In the following a device model is described that is usable to infer an amount of force sensed that may be used to perform the previously described techniques without use of a dedicated force sensor 118. Rather, functionality of the force sensor 118 may be realized by the position sensor 120. The force control module 116, for instance, may convert raw sensor values into absolute force units such as grams-force (gf); produce force estimates that are independent of contact size (e.g., finger area); use automatic gain control to adapt to a wide variety of environmental and electrical changes; and correct the effects of spatial aliasing and edge effects.

Accordingly, the force control module 116 incorporates techniques to estimate a size (e.g., area, width and height, major and minor axes) and signal strength (e.g., amplitude, average value, root-mean-square value) for each contact that is used to infer an amount of force applied to the outer surface 208. Signal strength, and thus amplitude, is a quantity that changes with an amount of force, even if in a non-linear manner, and multiple contacts produce independent estimates of size and amplitude.

An example of an input device 104 that incorporates these techniques is illustrated in FIG. 12. The input device 104 is implemented as a multi-touch resistive design with a rectangular grid 1202 of force-sensitive resistive (FSR) nodes illustrated as squares in the figure (arrayed with, for example, a 5 mm pitch). Combinations of the nodes are usable to define keys, trackpad functionality, and so on, an example of which is shown for the letter “A” 1204 that includes four nodes 1206, 1208, 1210, 1212. As an example, gestures may be supported across keys of the keyboard through combinations of nodes. The amplitude reported by each node is proportional to its conductance.

Other examples include a mutual capacitance sensor, with a layer of open-cell foam laminated over the capacitive electrodes. Under a zero-force contact, the foam is relaxed and acts as a spacer with known thickness and dielectric constant. Under force, the foam is compressed, such that the gap between the finger and the sensor electrodes reduces and the foam dielectric constant increases. This produces a measurable and repeatable change in capacitance, which can be used to estimate force. For this sensor, the amplitude reported by each node is proportional to the change in mutual capacitance with respect to its baseline value.

The force control module 116 is used to estimate a centroid, amplitude and area of contact, e.g., through use of a touch controller. These values are generally computed from a matrix of resistance or capacitance deltas, where each element of the matrix corresponds to a sensor node. Amplitude is proportional to peak deltas for a region receiving the application of force. In the illustrated example of FIG. 12, area is proportional to the number of nodes under a contact made by an object.

In the following, a model is first extracted using data obtained from a set of standardized test fingers with diameters covering a range of human finger sizes. For example, if 5.0-15.0 millimeter contact sizes are of interest, a set of fingers with 2.5, 5.0, 7.5, 10.0, 15.0 and 20.0 millimeter diameters can provide sufficient granularity and some margin. Depending on the application, rigid fingers with flat bottoms or flexible fingers may be used. For capacitive systems, the finger is grounded and either made of conductive material or wrapped in a conductive fabric. A robot is used in this example with an attachment mechanically compatible with the set of fingers, capable of applying arbitrary forces over the measurement range and equipped with a two-dimensional stage capable of moving a device under test.

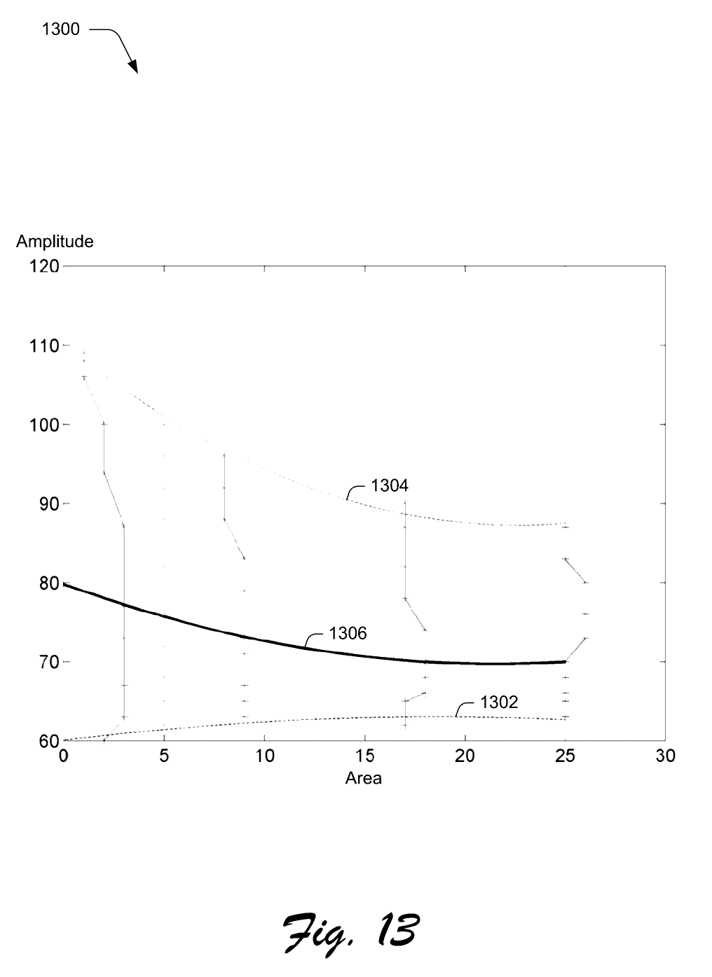

A set of locations receive the robot stimuli, e.g., five locations sufficiently away from the edges. The amount or force (i.e., force values) which are applied to the device under test is varied to span the sensor measurement range. A measurement routine involves moving the robot to the first test location, attaching a first test finger to the robot, and having the robot step through the force values defined above and record centroid, amplitude and area produced by the sensor. This continues for a variety of locations and uses a variety of different finger samples at each location. FIG. 13 depicts an example implementation 1300 for a real, measured operating characteristic, obtained on a manually operated mechanism over a single touch location. Sensor responses are measured at 20, 40, 60, 80, 100, 140, 180, 220, 260 and 300 gf, respectively.

To perform model fitting, for any arbitrary force value v (in grams-force), the sensor's amplitude response is modeled as “fᵥ(Area),” which is a scalar function of its area response. One way of obtaining such a function is by fitting a least-squares polynomial to the measured data, assuming “v” grams-force is part of the force values defined above. It will be recognized that while this example uses contact area to represent contact size, a multi-dimensional quantity may be used instead. For example, contact size may be defined as contact width and height. Alternatively, contact size may be defined as the major and minor axes of the ellipse produced by a least-squares fit. In general, “fᵥ(Size)” is not a curve but an n-manifold that partitions the product space of contact size and signal strength. Curves are used for purposes of illustration and are not intended to be limiting.

The first, second, and third curves 1302, 1304, 1306 of FIG. 13 are un-weighted least-squares second degree polynomials, fit to the responses at 20 gf, 300 gf and 100 gf, respectively. This result leads to the following observations. First, amplitude depends on finger size and may be a non-monotonic function of it. In particular, a naïve algorithm that simply sums the amplitude of all cells produces significant errors. For the force scale of interest and test conditions, the sensor response is located within the first and second curves 1302, 1304. In particular, responses significantly under the first curve 1302 are physically impossible under standard operating conditions. Responses significantly above the second curve 1304 are also impossible due to sensor saturation.

Since this sensor has two output values (i.e., amplitude and area) that are jointly correlated to force, a force threshold corresponds to a curve in the plane defined by the Cartesian product of area and amplitude. For example, the third curve 1306 serves as a threshold for 100 gf with points above the curve exceeding 100 gf, and points below under 100 gf.

Thus, the curves (or in general, n-manifolds) may be used to support a variety of functionality. As a threshold detector, for instance, the curves (or n-manifolds) may be used by the force control module 116 as a basis to determine a likelihood of whether a selection input is initiated or released as described above. In order to do so, a threshold curve (or n-manifold) is created by fitting the dataset to define a desired amount of force. For example, the third curve 1306 is an example threshold function for 100 gf.

Additionally, the first curve 1302 defines a threshold, beneath which responses are physically impossible under standard operating conditions. Accordingly, the first curve 1302 may act as a “zero force” curve in which combinations of signal strength (e.g. amplitude) and contact size (e.g., area) above the first curve 1302 likely involve an application of force and are thus “not hovering.” On the other hand, combinations of signal strength (e.g. amplitude) and contact size (e.g., area) below the first curve 1302 are likely hovering.

Thus, on position sensors 120 such as capacitive sensors described earlier, this n-manifold lies in the product space of contact size and signal strength, defined as area and amplitude in the example above. Points formed by combinations above the first curve 1302 are considered to be exerting greater than zero force, and points under this curve are considered to be hovering (not in contact with nor exerting force on the outer surface 208).

The use of a zero-force n-manifold provides better accuracy than simply using separate amplitude or area thresholds, which are the conventional techniques used to determine whether a capacitive contact is valid. Specifically, by ignoring contacts that are under the zero force n-manifold in combination with the techniques described above, the force control module 116 may accurately discriminate and ignore hovering contacts.

The use of n-manifolds in the product space of contact size and signal strength are also usable as part of control of drag operations as described above. For example, users can sometimes inadvertently release a contact during a long drag motion if the characteristics of a contact change during the drag operation, causing the contact down criteria not to be met as described in relation to FIG. 8. This can result in drag operations being interrupted or new tap and drags improperly occurring. Through use of the n-manifolds described herein, however, once a qualified contact is reported and a drag operation commences, communication of reports of contact may be maintained, thereby allowing a reduced criteria n-manifold to apply for termination of contact reporting, i.e., the end of the drag operation. For example, another n-manifold may be employed during movement that defines an amount of force to be detected that is sufficient to maintain the drag operation. The result being that a drag continues uninterrupted until a deliberate lift is encountered as defined by the reduced criteria n-manifold. As described above, force depends on contact size and amplitude. As such, the force control module 116 may be used to fit a parametric surface to a measured dataset and obtain a function mapping an area and amplitude pair into absolute force.

Example Procedures

The following discussion describes inadvertent input force control techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-13 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

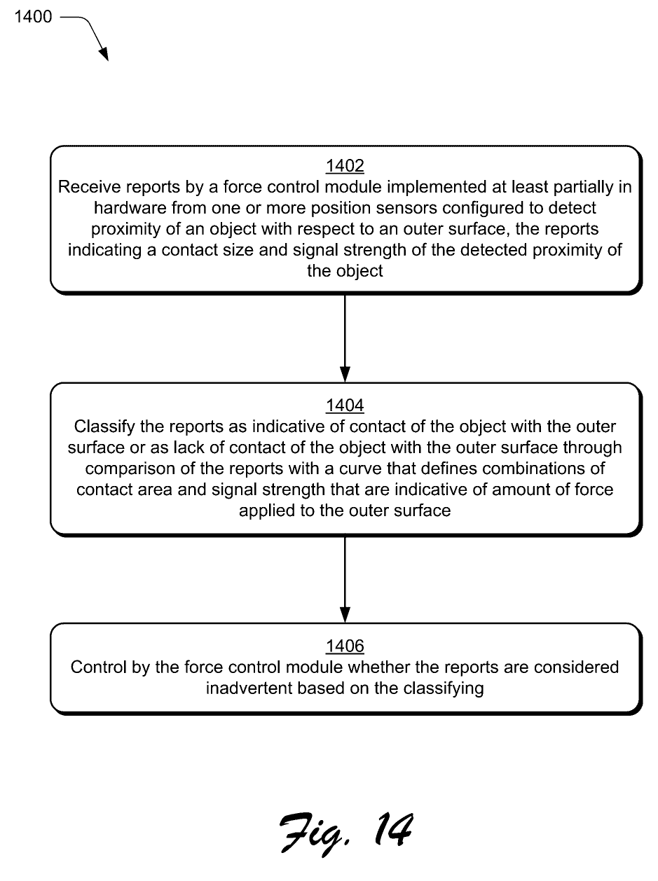

FIG. 14 depicts a procedure 1400 in an example implementation in which n-manifolds are used to classify whether or not reports are likely indicative of advertent or inadvertent inputs. Reports are received by a force control module implemented at least partially in hardware from one or more position sensors configured to detect proximity of an object with respect to an outer surface, the reports indicating a contact size and signal strength of the detected proximity of the object (block 1402). The reports, for instance, may be received by the force control module 116 from position sensors that are configured as capacitive sensors, arrays of nodes as shown in FIG. 12, and so on.

The reports are classified as indicative of contact of the object with the outer surface or as lack of contact of the object with the outer surface through comparison of the reports with an n-manifold that partitions the product space of contact size and signal strength and is indicative of a prescribed force applied to the outer surface (block 1404). The first curve 1302 of FIG. 13, for instance, may define a zero force 1-manifold such that reports having combinations of contact size and signal strength above the curve are considered advertent, and below inadvertent. The force control module controls whether the reports are considered inadvertent based on the classifying (block 1506), such as to block or permit further communication as described above. N-manifolds may be used for a variety of other functionality, such as to define movement in a drag operation, initiation of a selection input, and so on as described in relation to FIGS. 1-13.

Example System and Device

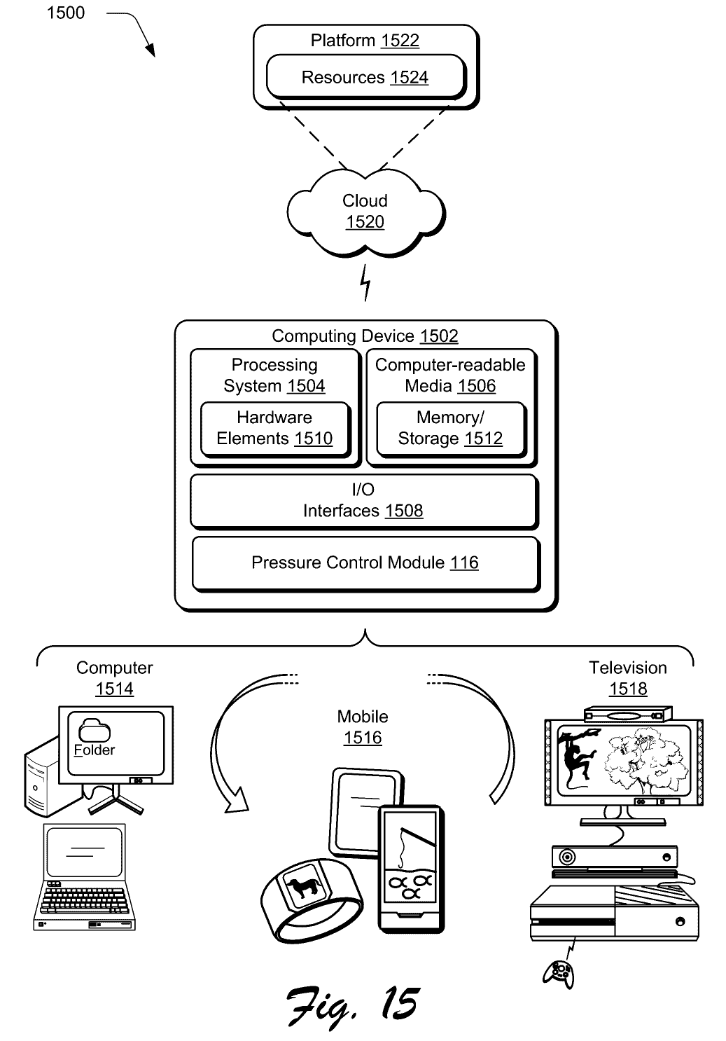

FIG. 15 illustrates an example system generally at 1500 that includes an example computing device 1602 that is representative of one or more computing systems and/or devices that may implement the various techniques described herein. This is illustrated through inclusion of the force control module 116. The computing device 1602 may be, for example, a server of a service provider, a device associated with a client (e.g., a client device), an on-chip system, and/or any other suitable computing device or computing system.

The example computing device 1502 as illustrated includes a processing system 1504, one or more computer-readable media 1506, and one or more I/O interface 1508 that are communicatively coupled, one to another. Although not shown, the computing device 1502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware element 1510 that may be configured as processors, functional blocks, and so forth. This may include implementation in hardware as an application specific integrated circuit or other logic device formed using one or more semiconductors. The hardware elements 1510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1506 is illustrated as including memory/storage 1512. The memory/storage 1512 represents memory/storage capacity associated with one or more computer-readable media. The memory/storage component 1512 may include volatile media (such as random access memory (RAM)) and/or nonvolatile media (such as read only memory (ROM), Flash memory, optical disks, magnetic disks, and so forth). The memory/storage component 1512 may include fixed media (e.g., RAM, ROM, a fixed hard drive, and so on) as well as removable media (e.g., Flash memory, a removable hard drive, an optical disc, and so forth). The computer-readable media 1506 may be configured in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a trackpad), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1510. The computing device 1502 may be configured to implement particular instructions and/or functions corresponding to the software and/or hardware modules. Accordingly, implementation of a module that is executable by the computing device 1502 as software may be achieved at least partially in hardware, e.g., through use of computer-readable storage media and/or hardware elements 1510 of the processing system 1504. The instructions and/or functions may be executable/operable by one or more articles of manufacture (for example, one or more computing devices 1502 and/or processing systems 1504) to implement techniques, modules, and examples described herein.

As further illustrated in FIG. 15, the example system 1500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1502 may assume a variety of different configurations, such as for computer 1514, mobile 1515, and television 1518 uses. Each of these configurations includes devices that may have generally different constructs and capabilities, and thus the computing device 1502 may be configured according to one or more of the different device classes. For instance, the computing device 1502 may be implemented as the computer 1514 class of a device that includes a personal computer, desktop computer, a multi-screen computer, laptop computer, netbook, and so on.

The computing device 1502 may also be implemented as the mobile 1515 class of device that includes mobile devices, such as a mobile phone, wearables (e.g., wrist bands, pendants, rings) portable music player, portable gaming device, a tablet computer, a multi-screen computer, and so on. The computing device 1502 may also be implemented as the television 1518 class of device that includes devices having or connected to generally larger screens in casual viewing environments. These devices include televisions, set-top boxes, gaming consoles, and so on. Other devices are also contemplated, such as appliances, thermostats and so on as part of the “Internet of Things.”

The techniques described herein may be supported by these various configurations of the computing device 1502 and are not limited to the specific examples of the techniques described herein. This functionality may also be implemented all or in part through use of a distributed system, such as over a “cloud” 1520 via a platform 1522 as described below.

The cloud 1520 includes and/or is representative of a platform 1522 for resources 1524. The platform 1522 abstracts underlying functionality of hardware (e.g., servers) and software resources of the cloud 1520. The resources 1524 may include applications and/or data that can be utilized while computer processing is executed on servers that are remote from the computing device 1502. Resources 1524 can also include services provided over the Internet and/or through a subscriber network, such as a cellular or Wi-Fi network.

The platform 1522 may abstract resources and functions to connect the computing device 1502 with other computing devices. The platform 1522 may also serve to abstract scaling of resources to provide a corresponding level of scale to encountered demand for the resources 1524 that are implemented via the platform 1522. Accordingly, in an interconnected device embodiment, implementation of functionality described herein may be distributed throughout the system 1500. For example, the functionality may be implemented in part on the computing device 1502 as well as via the platform 1522 that abstracts the functionality of the cloud 1520.

### Conclusion and Example Implementations

Example implementations described herein include, but are not limited to, one or any combinations of one or more of the following examples:

In one or more examples, a method comprises receiving reports by a force control module implemented at least partially in hardware from one or more position sensors configured to detect proximity of an object with respect to an outer surface, the reports indicating a contact size and signal strength of the detected proximity of the object; classifying the reports as indicative of contact of the object with the outer surface or as lack of contact of the object with the outer surface through comparison of the reports with an n-manifold that defines combinations of contact size and signal strength that are indicative of a prescribed amount of force applied to the outer surface; and controlling by the force control module whether the reports are considered inadvertent based on the classifying.

An example as described alone or in combination with any of the other examples described above or below, wherein the combinations of contact size and signal strength that are plotted above the n-manifold are indicative of force application and the combinations of contact size and signal strength that are plotted below the n-manifold are indicative of lack of force application.

An example as described alone or in combination with any of the other examples described above or below, wherein the combinations of contact size and signal strength that indicate lack of force application are indicative of hovering of the object in relation to the outer surface.

An example as described alone or in combination with any of the other examples described above or below, wherein the combinations of contact size and signal strength that indicate lack of force application are indicative of a lack of contact of the object with the outer surface.

An example as described alone or in combination with any of the other examples described above or below, wherein the controlling blocks the communication of inputs for the reports that are classified as indicative of the lack of force.

An example as described alone or in combination with any of the other examples described above or below, wherein the controlling permits the communication of inputs for the reports that are classified as indicative of force application.

An example as described alone or in combination with any of the other examples described above or below, wherein the one or more position sensors are capacitive sensors.

An example as described alone or in combination with any of the other examples described above or below, wherein a function of contact size and signal strength together estimate an applied force in an absolute force unit.

In one or more examples, a system comprises one or more position sensors configured to detect proximity of an object with respect to an outer surface; and a force control module implemented at least partially in hardware, the force control module configured to control whether the object is considered as initiating an input through classification of reports received from the one or more position sensors as indicative of force application by the object to the outer surface through use of a n-manifold defining: combinations of contact size and signal strength from the one or more position sensors that are indicative of force applied to the outer surface; and combinations of contact size and signal strength from the one or more position sensors that are indicative of lack of force applied to the outer surface.

An example as described alone or in combination with any of the other examples described above or below, wherein the combinations of contact size and signal strength that are plotted above the n-manifold are indicative of force application and the combinations of contact size and signal strength that are plotted below the n-manifold are indicative of lack of force application.

An example as described alone or in combination with any of the other examples described above or below, wherein the combinations of contact size and signal strength that indicate lack of force application are indicative of hovering of the object in relation to the outer surface.

An example as described alone or in combination with any of the other examples described above or below, wherein the combinations of contact size and signal strength that indicate lack of force application are indicative of a lack of contact of the object with the outer surface.

An example as described alone or in combination with any of the other examples described above or below, wherein the force control module is configured to block communication of inputs for the reports that are classified as indicative of the lack of force.

An example as described alone or in combination with any of the other examples described above or below, wherein the force control module is configured to permit the communication of inputs for the reports that are classified as indicative of force application.

An example as described alone or in combination with any of the other examples described above or below, wherein the one or more position sensors are capacitive sensors.

In one or more examples, a system comprises one or more position sensors configured to detect proximity of an object with respect to an outer surface; and a force control module implemented at least partially in hardware, the force control module configured to control whether the object is considered as initiating a select and drag operation through use of: a first n-manifold used to define initiation of the select and drag operation, the first n-manifold defining combinations of contact size and signal strength from the one or more position sensors that are indicative of a first prescribed force applied to the outer surface; and a second n-manifold used to define continuation of the select and drag operation during movement of the object, the second n-manifold defining combinations of contact size and signal strength from the one or more position sensors that are indicative of a second prescribed force applied to the outer surface that is less than the first prescribed force.

An example as described alone or in combination with any of the other examples described above or below, wherein the one or more position sensors are capacitive sensors.

An example as described alone or in combination with any of the other examples described above or below, wherein the one or more position sensors and the force control module are included as part of a trackpad.

An example as described alone or in combination with any of the other examples described above or below, wherein the combinations of contact size and signal strength between the first n-manifold and the second n-manifold during the movement of the object permit continued selection as part of the select and drag operation.

An example as described alone or in combination with any of the other examples described above or below, wherein combinations of contact size and signal strength below the second n-manifold indicate release of the select and drag operation.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
receiving reports by a force control module implemented at least partially in hardware from one or more position sensors configured to detect proximity of an object with respect to an outer surface, the reports indicating a contact size and signal strength of the detected proximity of the object;
classifying the reports as indicative of contact of the object with the outer surface or as lack of contact of the object with the outer surface through comparison of the reports with an n-manifold that defines combinations of contact size and signal strength that are indicative of a prescribed amount of force applied to the outer surface; and
controlling by the force control module whether the reports are considered inadvertent based on the classifying.

2. A method as described in claim 1, wherein the combinations of contact size and signal strength that are plotted above the n-manifold are indicative of force application and the combinations of contact size and signal strength that are plotted below the n-manifold are indicative of lack of force application.

3. A method as described in claim 2, wherein the combinations of contact size and signal strength that indicate lack of force application are indicative of hovering of the object in relation to the outer surface.

4. A method as described in claim 2, wherein the combinations of contact size and signal strength that indicate lack of force application are indicative of a lack of contact of the object with the outer surface.

5. A method as described in claim 1, wherein the controlling blocks the communication of inputs for the reports that are classified as indicative of the lack of force.

6. A method as described in claim 1, wherein the controlling permits the communication of inputs for the reports that are classified as indicative of force application.

7. A method as described in claim 1, wherein the one or more position sensors are capacitive sensors.

8. A method as described in claim 1, wherein a function of contact size and signal strength together estimate an applied force in an absolute force unit.

9. A system comprising:
one or more position sensors configured to detect proximity of an object with respect to an outer surface; and
a force control module implemented at least partially in hardware, the force control module configured to control whether the object is considered as initiating an input through classification of reports received from the one or more position sensors as indicative of force application by the object to the outer surface through use of a n-manifold defining:
combinations of contact size and signal strength from the one or more position sensors that are indicative of force applied to the outer surface; and
combinations of contact size and signal strength from the one or more position sensors that are indicative of lack of force applied to the outer surface.

10. A system as described in claim 9, wherein the combinations of contact size and signal strength that are plotted above the n-manifold are indicative of force application and the combinations of contact size and signal strength that are plotted below the n-manifold are indicative of lack of force application.

11. A system as described in claim 9, wherein the combinations of contact size and signal strength that indicate lack of force application are indicative of hovering of the object in relation to the outer surface.

12. A system as described in claim 9, wherein the combinations of contact size and signal strength that indicate lack of force application are indicative of a lack of contact of the object with the outer surface.

13. A system as described in claim 9, wherein the force control module is configured to block communication of inputs for the reports that are classified as indicative of the lack of force.

14. A system as described in claim 9, wherein the force control module is configured to permit the communication of inputs for the reports that are classified as indicative of force application.

15. A system as described in claim 9, wherein the one or more position sensors are capacitive sensors.

16. A system comprising:
one or more position sensors configured to detect proximity of an object with respect to an outer surface; and
a force control module implemented at least partially in hardware, the force control module configured to control whether the object is considered as initiating a select and drag operation through use of:
a first n-manifold used to define initiation of the select and drag operation, the first n-manifold defining combinations of contact size and signal strength from the one or more position sensors that are indicative of a first prescribed force applied to the outer surface; and
a second n-manifold used to define continuation of the select and drag operation during movement of the object, the second n-manifold defining combinations of contact size and signal strength from the one or more position sensors that are indicative of a second prescribed force applied to the outer surface that is less than the first prescribed force.

17. A system as described in claim 16, wherein the one or more position sensors are capacitive sensors.

18. A system as described in claim 16, wherein the one or more position sensors and the force control module are included as part of a trackpad.

19. A system as described in claim 16, wherein the combinations of contact size and signal strength between the first n-manifold and the second n-manifold during the movement of the object permit continued selection as part of the select and drag operation.

20. A system as described in claim 16, wherein combinations of contact size and signal strength below the second n-manifold indicate release of the select and drag operation.
